(19) United States
(12) Patent Application Publication
(10) Pub. No.: US 2012/0023831 A1
(43) Pub. Date: Feb. 2, 2012

(54) WEATHER STRIP AND ASSEMBLY STRUCTURE THEREOF

(75) Inventors: Michihiko MATSUMOTO, Hiroshima-shi (JP); Eiichi BABA, Hiroshima-shi (JP); Toshiyuki UEDA, Isehara-shi (JP)

(73) Assignee: NISHIKAWA RUBBER CO., LTD, Hiroshima-shi (JP)

(21) Appl. No.: 13/165,088

(22) Filed: Jun. 21, 2011

(30) Foreign Application Priority Data
Jul. 27, 2010 (JP) 2010-168272

(51) Int. Cl. B60J 10/08

(52) U.S. Cl. 49/489.1

(57) ABSTRACT

A weather strip 50 comprises: an assembly part 51 assembled between an anchoring part 5X on an outer-cabin side and an anchoring part 5Y on an inner-cabin side winch are provided on an outer peripheral side of an outer peripheral part2A of a door sash 2 of an automobile; and a hollow seal member 52 and an outer lip 53 integrally molded with an inner-cabin side and an outer-cabin side of the assembly pall 51 respectively, which make elastic contact with an inner-cabin side and an outer-cabin side of a door 1 opening edge of a body panel 3 respectively, wherein: a singular pillar part 54 connects the assembly part 51 with the hollow seal member 52; and the pillar part 54 comprises a curved part 54a.

This application claims the benefit under 35 USC 119 of JP Patent Application JP2010-168272 filed Jul. 27, 2010, the entire disclosure of which is incorporated herein by reference.

### BACKGROUND OF THE INVENTION

The present invention relates to: weather strips installed on a door sash of an automobile, which make elastic contact with a door opening edge of a body panel to seal a space between the body panel and the door sash; and assembly structure of the weather strips.

As shown in FIG. 6 and FIG. 7, a weather strip 10 is assembled on a door sash 2 of an automobile door I, which makes elastic contact with a door opening edge of a body panel 3 to seal a space between the door sash 2 and the body panel 3.

As shown in FIG. 7, the weather strip 10 comprises: an assembly part 11 assembled on an outer peripheral side of an outer peripheral part 2A of the door sash 2 of an automobile; and a hollow seal member 12 and a tongue-shaped outer lip 13 integrally molded with an inner-cabin side and an outer-cabin side of the assembly part 11 respectively, which make elastic contact with an inner-cabin side and an outer-cabin side of a door opening edge of a body panel 3 respectively when the door 1 is closed.

An inner peripheral part 2B of the door sash 2 also has a glass nm 20 installed thereon, comprising: a cross-section roughly U-shaped installation base member 21; and an outer-cabin side lip 22 and an inner-cabin side lip 23 integrally molded with both ends of the installation base member 21, which are slidably brought into contact with an outer-cabin side and an inner-cabin side of a door glass 4 that lifts and lowers.

The assembly part 11 of the weather strip 10 is assembled between an anchoring part 5X on an outer-cabin side and an anchoring part 5Y on an inner-cabin side, which are provided on the outer peripheral side of the outer peripheral part 2A of the door sash 2. The anchoring part 5X on the outer-cabin side and the anchoring part 5Y on the inner-cabin side can be formed by bending the door sash 2 but are formed on an outer-cabin side and an inner-cabin side of a retainer part 5b of a roughly T-shaped molding member 5 comprising a molding part 5a and a retainer part 5b. The molding member 5 is installed on the door sash 2 by a rivet 6.

The hollow seal member 12 is subjected to lap setting shown in FIG. 7(b) after assembly of the weather strip 10, in which the hollow seal member 12 is pressed against an outer surface of a garnish 7 provided on an inner-cabin side of the door sash 2 to prevent occurrence of an aperture therebetween. In another word, in FIG. 7(a) without the garnish 7 (FIG. 7(a) shows the garnish 7 in an imaginary line (two-dot chain lines)), the hollow seal member 12 is arranged on the door sash 2 side compared with a position on which surface of the garnish 7 is going to be provided and overlaps with the garnish 7.

In addition, the Japanese unexamined Patent Publication No. 2007-223484 discloses a weather strip 30 shown in FIG. 8, of which the hollow seal member 32 is directly subjected to the lap setting relative to the door sash 2 if the garnish 7 is not installed on the inner-cabin side of the door sash 2. In another word, in FIG. 8 without the door sash 2 (FIG. 8 shows the door sash 2 in an imaginary line (two-dot chain lines)), the hollow seal member 32 is arranged on an inner position on an inner-peripheral side compared with a position on which the door sash 2 is going to be provided.

However, the weather strip 10 according to the prior art shown in FIG. 7 has the structure that the hollow seal member 12 is subjected to the lap setting (FIG. 7(a)) and has one base root 12a and the other base root 12b integrally molded with an inner-cabin side surface and an outer surface on the inner-cabin side of the assembly part 11 respectively while both of the base roots 12a, 12b are spaced out from each other. Accordingly, when the weather strip 10 is assembled on the door sash 2 (FIG. 7(b)), an outer-cabin side wall part (part 130) of the hollow seal member 12 which rises from the assembly part 11 toward the body panel 3 side that is the outer peripheral side of the door sash 2 shrinks and generates wrinkles while the inner-peripheral side wall part (part 140) of the hollow seal member 12 which is from the assembly part 11 toward the garnish 7 side is extended. As a result, there has remained a problem that the resultant hollow seal member 12 is deformed compared with a prescribed shape.

Deformation of the hollow seal member 12 may result in decrease in sealing property.

The weather strip 30 according to the prior art shown in FIG. 8 has the structure that the hollow seal member 32 is connected to the assembly part 31 by a singular pillar part 34. The hollow seal member 32 is seamless and annular in cross section. Accordingly, even in case the hollow seal member 32 is subjected to the lap setting on the door sash 2, the hollow seal member 32 as a whole rotates toward the outer-cabin side (clockwise direction in FIG. 8) around a connecting position between the pillar part 34 and the assembly part 31 when the weather strip 30 is assembled on the door sash 2. The resultant rotation of the hollow seal member 32 as a whole does not cause partial deformation of the hollow seal member 32 shown in FIG. 7 including partial shrinkage and extension.

However, the singular pillar part 34 that connects the hollow seal member 32 to the assembly part 31 linearly extends from the outer-cabin side to the inner-cabin side, which is a vertical direction relative to the surface of the door 1. Accordingly, it is difficult to sufficiently swell the hollow seal member 32 in the direction in which the hollow seal member 32 rises from the pillar part 34 toward the body panel 3 side that is the outer peripheral side of the door sash 2.

In addition, the weather strip 10 and 30 shown in FIGS. 7 and 8 has the outer lip 13, 33 which rises from the assembly part 11, 31 fit between the anchoring part 5X on the outer-cabin side and the anchoring part 5Y on the inner-cabin side toward the body panel 3 side that is the outer peripheral side of the door sash 2. When the outer lip 13, 33 is subjected to external pressure 70 from the outer-cabin side toward the inner-cabin side while the automobile is moving, the assembly part 11, 31 rotates around a top end 80 of the anchoring part 5Y on the inner-cabin side which abuts the assembly part 11, 31 toward the inner-cabin side. There has also remained a problem that a protruding end 11a, 31a on the outer-cabin side of the assembly part 11, 31 floats toward the body panel 3 side for the effect of the rotation and easily comes off from the anchoring part 5X on the outer-cabin side.

As shown in FIG. 9, countermeasures to the problems include: swelling the assembly part 11 and forming a hollow part 15; and raising anchoring degree of the anchoring part 5X on the outer-cabin side relative to the assembly part 11. But forming the hollow part 15 decreases rigidity whereas raising the anchoring degree deteriorates operability because fitting the assembly part 11 requires force to some extent. Also, manufacturing such a weather strip 10 is difficult.

Therefore, an object of the present invention is to provide weather strips and assembly structure thereof, capable of maintaining shape of the hollow seal member after the assembly.

Another object of the present invention is to provide weather strips and assembly structure thereof, prevented from coming off after the assembly.

### SUMMARY OF THE INVENTION

In order to achieve the above-mentioned object, according to one aspect of the invention a weather strip is provided, comprising: an assembly part (51) assembled between an anchoring part (5X) on an outer-cabin side and an anchoring part (5Y) on an inner-cabin side which are provided on an outer peripheral side of an outer peripheral part (2A) of a door sash (2) of an automobile; and a hollow seal member (52) and an outer lip (53) integrally molded with an inner-cabin side and an outer-cabin side of said assembly part (51) respectively, which make elastic contact with an inner-cabin side and an outer-cabin side of a door (1) opening edge of a body panel (3) respectively, wherein: a singular pillar part (54) connects said assembly part (51) with said hollow seal member (52); and said pillar part (54) comprises curved parts (54a, 54b).

In addition, according to an aspect of the present invention, the curved part of said pillar part (54) comprises an outer peripheral surface (54AM) of an arc which faces said door sash (2) side. In addition, according to an aspect of the present invention, said singular pillar part (54) is cross-section roughly S-shaped that connects the curved part (54b) with the assembly part (51) side of the curved part (54a); an outer peripheral surface (54BM) of an arc of the curved part (54b) faces an opposite side from said door sash (2) side while an outer peripheral surface (54AM) of an arc of the curved part (54a) faces said door sash (2) side.

In addition, according to an aspect of the present invention, an anchoring part (5Y) on the inner-cabin side, provided on said door sash (2), has a top end thereof extended in such a manner as to touch a connecting position between said singular pillar part (54) and said assembly part (51).

In addition, according to an aspect of the present invention, the connecting position between said singular pillar part (54) and said hollow seal member (52) is on said door sash (2) side compared with the top end of the anchoring part (5Y) on the inner-cabin side provided on said door sash (2).

In addition, according to an aspect of the present invention, said anchoring part (5Y) on the inner-cabin side comprises: a cross-section concave receiving part (5Ya) which opens toward an outer-cabin side and in which a protruding end (51b) on an inner-cabin side formed on the assembly part (51) of said weather strip (50) is fit; and a rising part (5Yb) bent from an outer peripheral side end of said receiving part (5Ya) toward an inner-cabin side.

Symbols in parentheses show constituents or items corresponding to Figures and DESCRIPTION OF PREFERRED EMBODIMENT.

With the structure of the present invention, since the singular pillar part connects the assembly part with the hollow seal member, even in case the hollow seal member is subjected to the lap setting on the door sash, the garnish or the like, the hollow seal member as a whole rotates toward the outer-cabin side around the connecting position between the pillar part and the assembly part when the weather strip is assembled on the door sash. As a result, shape of the hollow seal member is maintained and does not deform.

Accordingly, the hollow seal member of the weather strip according to the structure of the present invention does not partially deform including a shrunk part and an extended part as the weather strip according to the prior art (FIG. 7). Therefore, the weather strip according to the structure of the present invention is not degraded in the sealing function of filling up a space by elastic contact between the hollow seal member and the body panel when the door is closed.

In addition, the pillar part which connects the assembly part with the hollow seal member comprises the curved parts. Accordingly, in case the outer peripheral surface of the arc faces the door sash side as a structure of the invention, the connecting position between the pillar part and the hollow seal member is brought close to the door sash side compared with the pillar part according to the weather strip of the prior art (FIG. 8) which linearly extends. As a result, it becomes possible to swell the hollow seal member sufficiently in the direction in which the hollow seal member rises from the pillar part toward the body panel side, thereby improving sealing property. In addition, in case the hollow seal member laps on the door sash or the garnish provided on the door sash on the position on the inner peripheral side compared with a linear line extending from the door sash having the assembly part assembled thereon toward the inner-cabin side, a linear pillar part widely separates the lap position from the assembly part toward the inner-cabin side whereas a pillar part swelled and curved toward the door sash side brings the lap position close to the assembly part.

The pillar part supports the hollow seal member as a whole when rotating the hollow seal member in the direction receding from the door sash side toward the outer-cabin side. Accordingly, in order to prevent deformation of the hollow seal member after assembly, the connecting position between the pillar part and the hollow seal member is preferably on a position on the hollow seal member that is close to the door sash side.

In addition, providing a protrusion for sealing (which may be made of the same or different material from that of the hollow seal member, of which an example is sponge material made of rubber having specific gravity of 0.1 to 0.4) between the hollow seal member and the door sash in a manner shown in FIG. 1(b) prevents separation of the protrusion for sealing from the door sash.

In addition, the singular pillar part is cross-section roughly S-shaped that connects one curved part with the assembly part side of the other curved part; the outer peripheral surface of the arc of the one curved part faces the opposite side from the door sash side while the outer peripheral surface of the arc of the other curved part faces the door sash side. Such a structure shortens a distance between the hollow seal member and the assembly part in addition to the effect of the structure of the invention.

In addition, an anchoring part on the inner-cabin side, provided on the door sash which has an assembly part assembled thereon has a top end thereof extended in such a manner as to touch a connecting position between the singular pillar part and the assembly part. According to the structure, when the outer lip integrally molded with the assembly part is subjected to external pressure from the outer-cabin side toward the inner-cabin side, the assembly part rotates relative to the door sash around the top end of the extended anchoring part on the inner-cabin side. In another word, a central position of the rotation of the assembly part is a position on the outer peripheral side at a distance from the door sash so that a protruding end on the outer-cabin side of the assembly part is prevented from floating toward the body panel side and coming off from the anchoring part on the outer-cabin side.

Therefore, countermeasures such as swelling the assembly part and forming the hollow part or raising anchoring degree of the anchoring part on the outer-cabin side relative to the assembly part, disclosed in the prior art become unnecessary.

In addition, the connecting position between the singular pillar part and the hollow seal member is on the door sash side compared with the top end of the anchoring part on the inner-cabin side provided on the door sash. According to the structure, the connecting position between the pillar part and the hollow seal member is brought closer to the door sash side. As a result, it is possible to sufficiently swell the hollow seal member in the direction in which the hollow seal member rises from the pillar part toward the body panel side to improve the sealing property.

In addition, the anchoring part on the inner-cabin side comprises: a cross-section concave receiving pail which opens toward an outer-cabin side and in which a protruding end on all inner-cabin side formed on the assembly part of the weather strip is fit; and a rising part bent from an outer peripheral side end of the receiving part toward an inner-cabin side. Accordingly, the resultant assembly structure of the weather strip is simple in structure.

### BRIEF DESCRIPTION OF THE DRAWINGS

FIGS. 1(a) and 1(b) are I-I line enlarged cross sections of FIG. 6 showing assembly structure of a weather strip according to first embodiment of the present invention, of which FIG. 1(b) has a protrusion for sealing additionally provided on FIG. 1(a);

FIG. 2 is a cross section of FIG. 1(a) of which the weather strip is deflected;

FIG. 3 is a I-I line enlarged cross section of FIG. 6 showing assembly structure of a weather strip according to second embodiment of the present invention;

FIG. 4 is a I-I line enlarged cross section of FIG. 6 showing assembly structure of a weather strip according to another embodiment of the present invention;

FIGS. 5(a) and 5(b) are I-I line enlarged cross section of FIG. 6 showing assembly structure of a weather strip according to still another embodiment of the present invention;

FIG. 6 is a lateral view of an automobile;

FIGS. 7(a) and 7(b) are I-I line enlarged cross sections of FIG. 6 showing assembly structure of a weather strip according to a prior art, of which FIG. 7(a) shows a case without a garnish and FIG. 7(b) shows a case with the garnish;

FIG. 8 is a I-I line enlarged cross section of FIG. 6 showing assembly structure of a weather strip according to another prior art; and

FIG. 9 is a I-I line enlarged cross section of FIG. 6 showing assembly structure of a weather strip according to still another prior art.

### DESCRIPTION OF PREFERRED EMBODIMENT

### First Embodiment

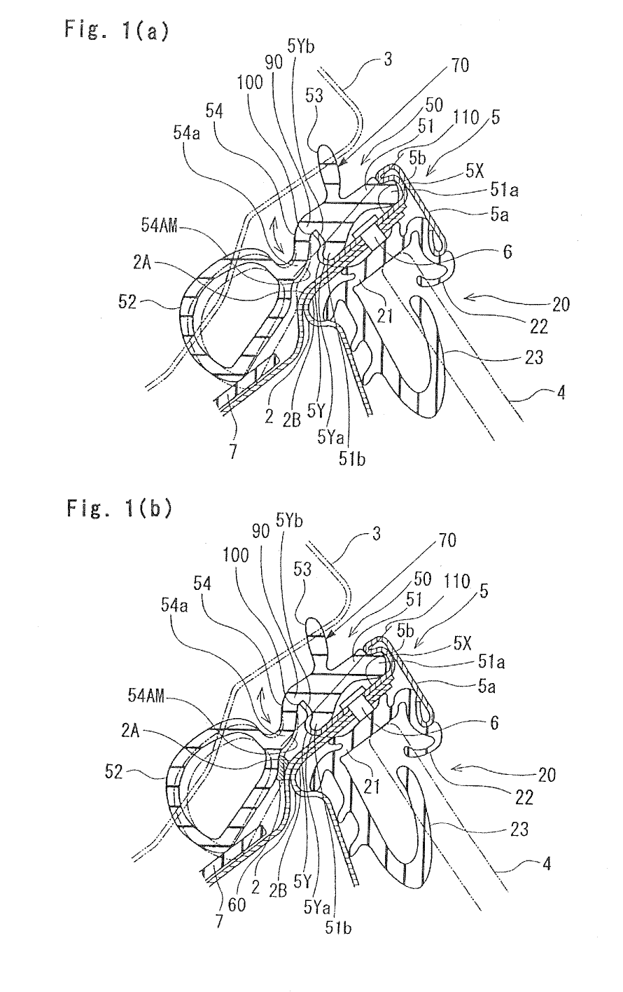

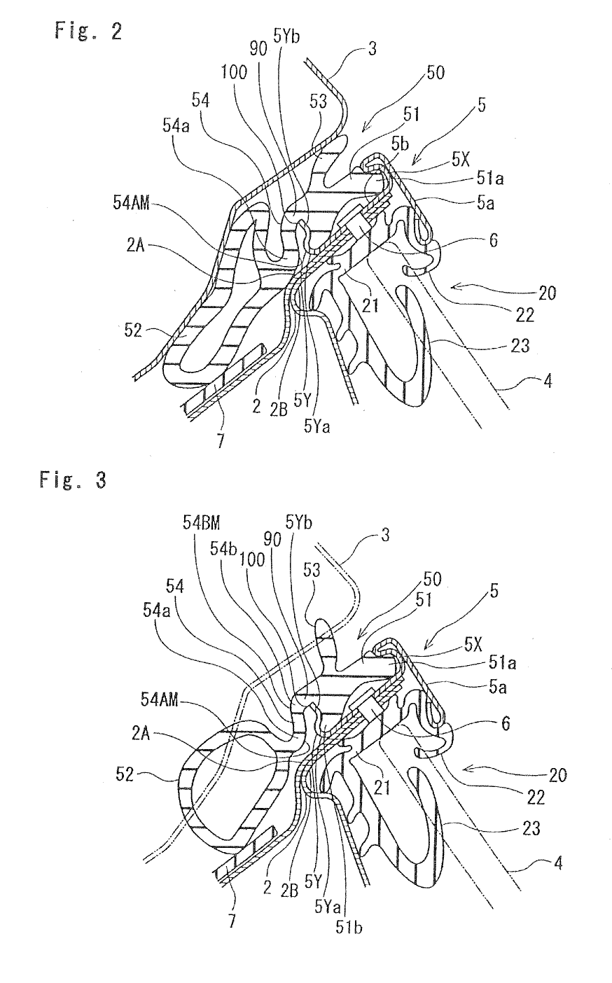

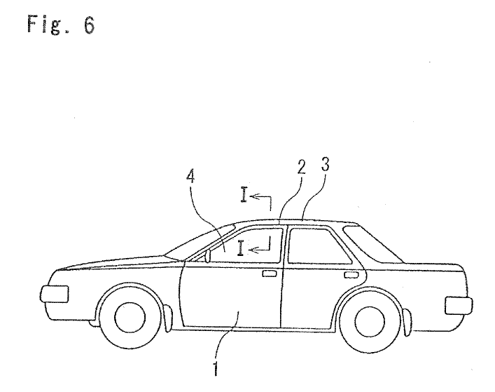

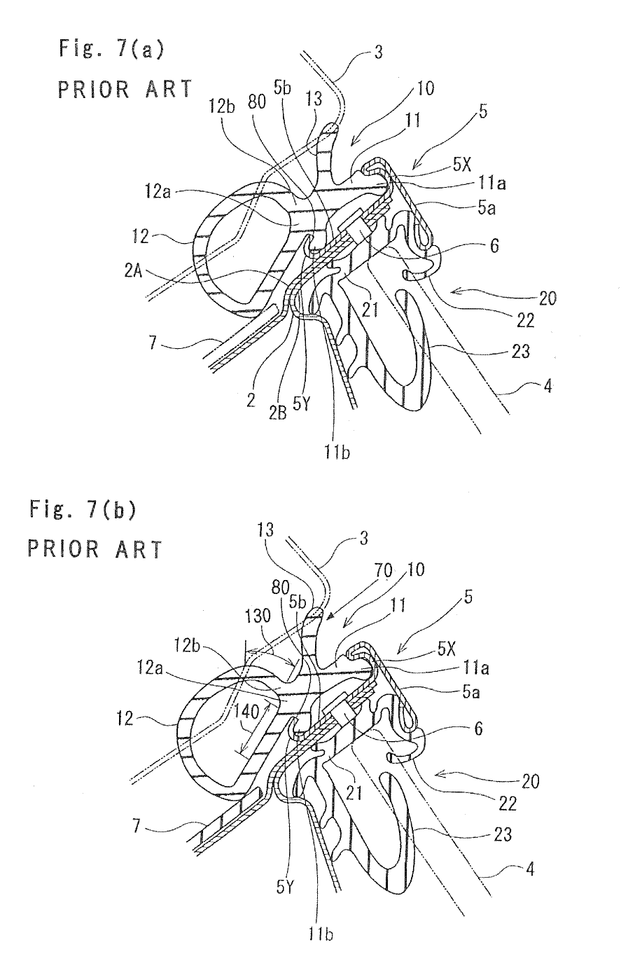

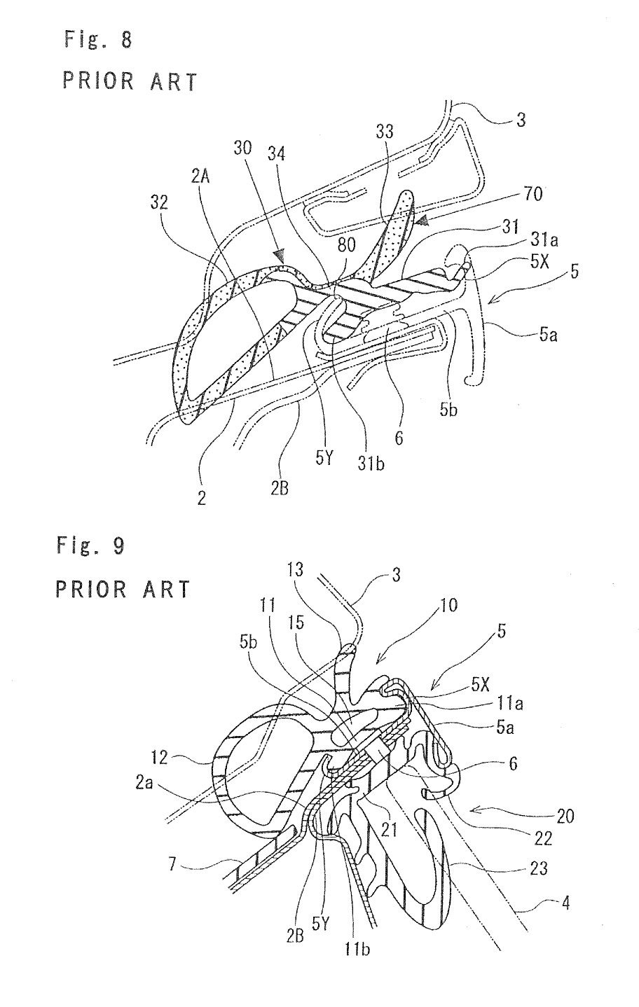

Referring to FIG. 1 and FIG. 2, a weather strip 50 and assembly structure of the weather strip 50 according to the first embodiment of the present invention will be described. FIG. 1 are I-I line enlarged cross sections of FIG. 6 showing assembly structure of the weather strip 50 according to first embodiment of the present invention before making elastic contact with the body panel 3. FIG. 1(b) has a protrusion for sealing additionally provided on 1(a). FIG. 2 is a cross section of FIG. 1(a) of which weather strip 50 shown in FIG. 1(a) makes elastic contact with the body panel 3 and is deflected. When constituents or items correspond to those in prior arts, the same symbols are used.

As shown in FIG. 1(a), a weather strip 50 according to the first embodiment of the present invention comprises: an assembly part 51 assembled on an outer peripheral side of an outer peripheral part 2A of a door sash 2 of an automobile; and a hollow seal member 52 and an outer lip 53 integrally molded with an inner-cabin side and outer-cabin side of the assembly part 51 respectively, which make elastic contact with an inner-cabin side and an outer-cabin side of a door opening edge of a body panel 3 respectively when a door 1 is closed to seal a space between the body panel 3 and the door sash 2.

An inner peripheral part 2B of the door sash 2 also has a glass run 20 installed thereon, comprising: a cross-section roughly U-shaped installation base member 21; and an outer-cabin side lip 22 and an inner-cabin side lip 23 integrally molded with both ends of the installation base member 21, which are slidably brought into contact with an outer-cabin side and an inner-cabin side of a door glass 4 that lifts and lowers.

The assembly part 51 of the weather strip 50 is assembled between the anchoring pail 5X on the outer-cabin side and the anchoring part 5Y on the inner-cabin side. Specifically, the assembly part 51 has a protruding edge 51a on an outer-cabin side formed on an outer-cabin side of a bottom side (door sash 2 side) thereof and a protruding edge 51b on an inner-cabin side formed on an inner-cabin side of the bottom side (door sash 2 side) thereof. The protruding edge 51a on the outer-cabin side is fit into the anchoring part 5X on the outer-cabin side which is provided on an outer-peripheral side of an outer peripheral part 2A of the door sash 2, open toward an inner-cabin side and formed by curving a cross-section concave receiving part whereas the protruding edge 51b on the inner-cabin side is fit into the anchoring part 5Y on the inner-cabin side which is provided on the outer-peripheral side of the outer peripheral part 2A of the door sash 2, open toward an outer-cabin side and formed by curving a cross-section concave receiving part.

The anchoring part 5X on the outer-cabin side and the anchoring part 5Y on the inner-cabin side may be formed by bending the door sash 2. In the present embodiment, the anchoring part 5X on the outer-cabin side and the anchoring part 5Y on the inner-cabin side are respectively formed on the outer-cabin side and the inner-cabin side of the a retainer 5b of a cross section roughly T-shaped molding material 5 comprising a molding part 5a which is exposed to the outer-cabin side to decorate the door sash 2 and the retainer 5b which extends toward the inner-cabin side. The molding material 5 is installed on the door sash 2 by a rivet 6. The molding member 5 is so called “luminous molding” of which molding part 5a is colored silver and mirro-surface finished, which gives sense of luxuriousness to the automobile by shining the automobile in silver color.

The hollow seal member 52 of the weather strip 50 is seamless and annular in cross section. The hollow seal member 52 is subjected to lap setting in which the hollow seal member 52 is pressed against an outer surface of a garnish 7 provided on an inner-cabin side of the door sash 2 to prevent occurrence of an aperture therebetween after assembly of the weather strip 50. In another word, according to FIG. 1 without the garnish 7, which is shown by an imaginary line (two-dot chain lines), the hollow seal member 52 is arranged on the door sash 2 side compared with a position on which surface of the garnish 7 is going to be provided and overlaps with the garnish 7.

An outer lip 53 of the weather strip 50 is tongue-shaped in cross section and is integrally molded with an outer-peripheral side of the assembly part 51 between the anchoring part 5X on the outer-cabin side and the anchoring part 5Y on the inner-cabin side. The outer lip 53 extends in such a manner as to rise from the assembly part 51 toward the body panel 3 side which faces the assembly part 51.

A singular pillar part 54 connects the assembly part 51 with the hollow seal member 52. The pillar part 54 comprises a curved part 54a which curves toward the door sash 2 side. The pillar part 54 has one end connected to a corner on an outer peripheral side spaced out from the door sash 2 which is on an inner-cabin side of the assembly part 51 and the other end connected to an inner peripheral side close to the door sash 2 which is on the outer-cabin side of the hollow seal member 52. Specifically, the outer peripheral surface 54AM of an arc between one end of the pillar part 54 which is connected to the assembly part 51 along the other end of the pillar part 54 on the hollow seal member 52 side faces (fronts) the door sash 2 side.

Formation of curved part 54a which curves toward the door sash 2 side generates a concave part between the hollow seal member 52 and the curved part 54a. Width and depth in outer and inner cabin directions of the concave part is set to prevent the hollow seal member 52 from abutting the pillar part 54 side while the door 1 is closed and the hollow seal member 52 makes elastic contact with the body panel 3 as shown in FIG. 2. The curved part 54a may be swelled and curved toward the door sash 2 side.

The assembly part 51 of the weather strip 50 has a protruding end 51b formed on an inner-cabin side thereof. The protruding end 51b is fit in an anchoring part 5Y on the inner-cabin side. A top end of the anchoring part 5Y on the inner-cabin side which is an outer peripheral side end of the cross-section concave receiving part 5Ya on the anchoring part 5Y on the inner-cabin side has a rising part 5Yb bent toward the inner-cabin side. The rising part 5Yb is bent toward the inner-cabin side into a cross-section L-shape relative to the direction in which the anchoring part 5Y on the inner-cabin side extends. The top end of the rising part 5Yb touches a connecting position between the assembly part 51 and the pillar part 54 from an inner peripheral side.

The connecting part between the pillar part 54 and the hollow seal member 52 is positioned on the door sash 2 side compared with the top end of the rising part 5Yb on the top end of the anchoring part 5Y on the inner-cabin side.

According to the above-structured weather strip 50 of the present embodiment, since the singular pillar part 54 connects the assembly part 51 with the hollow seal member 52, the pillar part 54 supports the hollow seal member 52 as a whole.

Accordingly, even in case the hollow seal member 52 is subjected to the lap setting on a garnish 7 provided on the door sash 2, the hollow seal member 52 as a whole rotates toward the outer-cabin side (clockwise direction in FIG. 1) around a connecting position 90 between the pillar part 54 and the assembly part 51 when the weather strip 50 is assembled on the door sash 2. Therefore, shape of the hollow seal member 52 is maintained.

Such a structure prevents partial deformation of the hollow seal member 52 including partial shrinkage and extension, thereby preventing degradation in sealing function of filling up a space by elastic contact between the hollow seal member 52 and the body panel 3 when the door 1 is closed.

In addition, the singular pillar part 54 which connects the assembly part 51 with the hollow seal member 52 comprises the part 54a swelled and curved toward the door sash 2 side. Accordingly, the connecting position between the pillar part 54 and the hollow seal member 52 is brought close to the door sash 2 side. As a result, it becomes possible to swell the hollow seal member 52 sufficiently in the direction in which the hollow seal member 52 rises from the pillar part 54 toward the body panel 3 side, thereby improving sealing property. In addition, when the connecting position between the pillar part 54 and the hollow seal member 52 is brought close to the door sash 2 side, the lap position of the hollow seal member 52 on the garnish 7 on the door sash 2 is brought close to the assembly part 51.

Further, since the connecting position between the pillar part 54 and the hollow seal member 52 is positioned on the hollow seal member 52 that is close to the door sash 2 side, the pillar part 54 supports the hollow seal member 52 as a whole from a lower side (door sash 2 side). Such a structure simplifies the rotation of the hollow seal member 52 toward the outer cabin side (clockwise direction in FIG. 1).

According to the weather strip 50 of the present embodiment, the anchoring part 5Y on the inner-cabin side, which is provided on the door sash 2 having the assembly part 51 assembled thereon, comprises a receiving part 5Ya and a rising part 5Yb while the top end 100 of the rising part 5Yb extends in such a manner as to touch the connecting position between the singular pillar part 54 and the assembly part 51 from the inner peripheral side. According to the structure, when the outer lip 53 integrally molded with the assembly part 51 is subjected to external pressure 70 from the outer-cabin side toward the inner-cabin side as shown in FIG. 1, central position of the rotation of the assembly part 51 relative to the door sash 2, that is the top end 100 of the rising part 5Yb in the present embodiment, is on a higher position farther from the door sash 2 compared with a fitting position line 110 connecting an end on the receiving part of the anchoring part 5Y on the inner-cabin side at a distance from the door sash 2 and an end on the anchoring part 5X on the outer-cabin side at a distance from the door sash 2. Such a structure improves fitting and holding force of the assembly part 51 at the time of assembly and prevents rotation of the assembly part 51 by external pressure 70, which causes the protruding end 51a on the outer-cabin side to float up and come off from the anchoring part 5X on the outer-cabin side.

In addition, a protrusion for sealing 60 (which may be made of the same or different material from that of the hollow seal member 52, of which an example is sponge material made of rubber having specific gravity of 0.1 to 0.4) may be provided between the hollow seal member 52 and the door sash2 in a manner shown in FIG. 1(b). The protrusion for sealing 60 is integrally molded with the hollow seal member 52 or adhered on the hollow seal member 52.

### Second Embodiment

Referring to FIG. 3, a weather strip 50 and assembly structure of the weather strip 50 according to the second embodiment of the present invention will be described. FIG. 3 is a I-I line enlarged cross section of FIG. 6 showing assembly structure of a weather strip according to second embodiment of the present invention. When constituents or items correspond to those in the first embodiment, the same symbols are used.

Second embodiment differs from the first embodiment in the shape of the singular pillar part 54 which connects the assembly part 51 and the hollow seal member 52 of the weather strip 50. The pillar part 54 according to the first embodiment comprises a curved part 54a curved toward the door sash 2 side. The pillar part 54 according to the second embodiment is cross-section roughly S-shaped which comprises a curved part 54b which is curved toward an opposite side from the door sash 2 side and formed on an assembly part 51 side of the curved part 54a curved toward the door sash 2 side. More specifically, the singular pillar part 54 is cross-section roughly S-shaped that connects the curved part 54b with the assembly part 51 side of the curved part 54a; an outer peripheral surface 54BM of an arc of the curved part 54b faces an opposite side from the door sash 2 side (body panel 3 side when the door 1 is closed) while an outer peripheral surface 54AM of an arc of the curved part 54a faces the door sash 2 side. The curved part 54a may also be swelled and curved toward the door sash 2 side and the curved part 54b may be swelled and curved toward an opposite side from the door sash 2 side.

Other constituents are the same as those in the first embodiment of the present invention.

The cross-section roughly S-shaped pillar part 54 shortens the distance between the hollow seal member 52 and the assembly part 51 compared with the pillar part 54 of the first embodiment of the present invention. Such a structure simplifies the countermeasures to deal with unevenness in assembly state that generates at the time assembly.

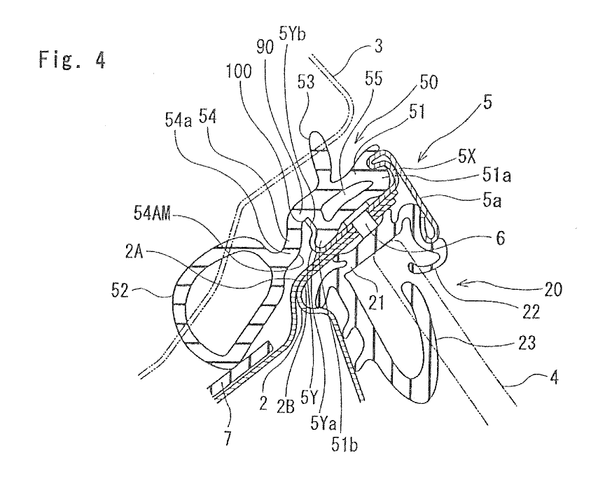

In the first and the second embodiments of the present invention, the rising part 5Yb on the receiving part 5Ya of the anchoring part 5Y on the inner-cabin side improves holding force of the assembly part 51 as assembled. Such a structure prevents the protruding edge 51a on the outer-cabin side from easily floating up and coming off from the anchoring part 5X on the outer-cabin side even in case the assembly part 51 is solid. A hollow part 55 may be formed in the assembly part 51 as shown in FIG. 4 in order to further improve the holding force.

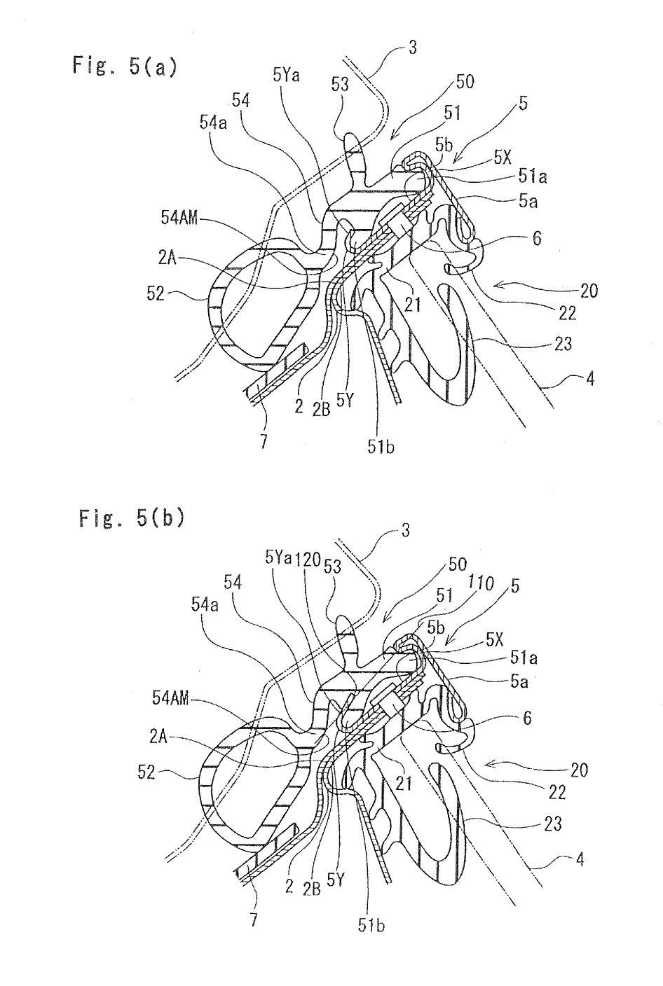

In case the rising part 5Yb is not provided on the receiving pall 5Ya of the anchoring part 5Y on the inner-cabin side as shown in FIG. 5(a), the holding force of the assembly part 51 as assembled is not especially improved. But the singular pillar part 54 which connects the assembly part 51 with the hollow seal member 52 enables to assemble the hollow seal member 52 subjected to the lap setting on a garnish 7 while a hollow shape thereof is maintained.

In addition, as shown in FIG. 5(b), in case a top end 120 is on a higher position farther from the door sash 2 compared with the fitting position line 110 (line connecting the end on the receiving part of the anchoring part 5Y on the inner-cabin side at a distance from the door sash 2 and the end on the anchoring part 5X on the outer-cabin side at a distance from the door sash 2) where the top end 120 is formed by linearly extending the receiving part 5Ya of the anchoring part 5Y on the inner-cabin side toward the outer-cabin side in such a manner as to touch the assembly part 51 and is inserted into the assembly part 51, fitting and holding force of the assembly part 51 at the time of assembly is improved.

While the present embodiment specifies an example where the hollow seal member 52 of the weather strip 50 is subjected to the lap setting relative to the garnish 7 provided on the door sash 2, the present invention is also applicable on structures that: the hollow seal member 52 is subjected to the lap setting on any substitute laying member other than the garnish 7; or the hollow seal member 52 is subjected to the lap setting relative to the door sash 2 without the garnish 7.

We claim;

1. A weather strip comprising: an assembly part assembled between an anchoring part on an outer-cabin side and an anchoring part on an inner-cabin side which are provided on an outer peripheral side of an outer peripheral part of a door sash of an automobile; and a hollow seal member and an outer lip integrally molded with an inner-cabin side and an outer-cabin side of said assembly part respectively, which make elastic contact with an inner-cabin side and an outer-cabin side of a door opening edge of a body panel respectively, wherein:
a singular pillar part connects said assembly part with said hollow seal member; and
said pillar part comprises curved parts.

2. The weather strip as claimed in claim 1, wherein:
the curved part of said pillar part comprises an outer peripheral surface of an arc which faces said door sash side.

3. The weather strip as claimed in claim 1, wherein:
said singular pillar part is cross-section roughly S-shaped that connects one curved part with the assembly part side of the other curved part; an outer peripheral surface of an arc of the one curved part faces an opposite side from said door sash side while an outer peripheral surface of an arc of the other curved part faces said door sash side.

4. An assembly structure of a weather strip on a door sash, said weather strip comprising: a an assembly part assembled between an anchoring part on an outer-cabin side and an anchoring part on an inner-cabin side which are provided on an outer peripheral side of an outer peripheral part of a door sash of an automobile; and a hollow seal member and an outer lip integrally molded with an inner-cabin side and an outer-cabin side of said assembly part respectively, which make elastic contact with an inner-cabin side and an outer-cabin side of a door opening edge of a body panel respectively, in which
a singular pillar part connects said assembly part with said hollow seal member and
said pillar part comprises curved parts, wherein:
an anchoring part on the inner-cabin side, provided on said door sash, has a top end thereof extended in such a manner as to touch a connecting position between said singular pillar part and said assembly part.

5. An assembly structure of a weather strip on a door sash, said weather strip comprising: an assembly part assembled between an anchoring part on an outer-cabin side and an anchoring part on an inner-cabin side which are provided on an outer peripheral side of an outer peripheral part of a door sash of an automobile; and a hollow seal member and an outer lip integrally molded with an inner-cabin side and an outer-cabin side of said assembly part respectively, which make elastic contact with an inner-cabin side and an outer-cabin side of a door opening edge of a body panel respectively, in which
a singular pillar part connects said assembly part with said hollow seal member,
said pillar part comprises curved parts and
the curved part of said pillar part comprises an outer peripheral surface of an arc which faces said door sash side, wherein:
an anchoring part on the inner-cabin side, provided on said door sash, has a top end thereof extended in such a manner as to touch a connecting position between said singular pillar part and said assembly part.

6. An assembly structure of a weather strip on a door sash, said weather strip comprising: an assembly part assembled between an anchoring part on an outer-cabin side and an anchoring part on an inner-cabin side which are provided on an outer peripheral side of an outer peripheral part of a door sash of an automobile; and a hollow seal member and an outer lip integrally molded with an inner-cabin side and an outer-cabin side of said assembly part respectively, which make elastic contact with an inner-cabin side and an outer-cabin side of a door opening edge of a body panel respectively, in which
a singular pillar part connects said assembly part with said hollow seal member,
said pillar part comprises curved parts and
said singular pillar part is cross-section roughly S-shaped that connects one curved part with the assembly part side of the other curved part; an outer peripheral surface of an arc of the one curved part faces an opposite side from said door sash side while an outer peripheral surface of an arc of the other curved part faces said door sash side, wherein:
an anchoring part on the inner-cabin side, provided on said door sash, has a top end thereof extended in such a manner as to touch a connecting position between said singular pillar part and said assembly part.

7. An assembly structure of a weather strip on a door sash, said weather strip comprising: a an assembly part assembled between an anchoring pail on an outer-cabin side and an anchoring part on an inner-cabin side which are provided on an outer peripheral side of an outer peripheral part of a door sash of an automobile; and a hollow seal member and an outer lip integrally molded with an inner-cabin side and an outer-cabin side of said assembly part respectively, which make elastic contact with an inner-cabin side and an outer-cabin side of a door opening edge of a body panel respectively, in which
a singular pillar part connects said assembly part with said hollow seal member and
said pillar part comprises curved parts, wherein:
a connecting position between said singular pillar part and said hollow seal member is on said door sash side compared with the top end of the anchoring part on the inner-cabin side provided on said door sash.

8. An assembly structure of a weather strip on a door sash, said weather strip comprising: an assembly part assembled between an anchoring part on an outer-cabin side and an anchoring part on an inner-cabin side which are provided on an outer peripheral side of an outer peripheral part of a door sash of an automobile; and a hollow seal member and an outer lip integrally molded with an inner-cabin side and an outer-cabin side of said assembly part respectively, which make elastic contact with an inner-cabin side and an outer-cabin side of a door opening edge of a body panel respectively, in which
a singular pillar part connects said assembly part with said hollow seal member,
said pillar part comprises curved parts and
the curved part of said pillar part comprises an outer peripheral surface of an arc which faces said door sash side, wherein:
a connecting position between said singular pillar part and said hollow seal member is on said door sash side compared with the top end of the anchoring part on the inner-cabin side provided on said door sash.

9. An assembly structure of a weather strip on a door sash, said weather strip comprising: an assembly part assembled between an anchoring part on an outer-cabin side and an anchoring part on an inner-cabin side which are provided on an outer peripheral side of an outer peripheral part of a door sash of an automobile; and a hollow seal member and an outer lip integrally molded with an inner-cabin side and an outer-cabin side of said assembly part respectively, which make elastic contact with an inner-cabin side and an outer-cabin side of a door opening edge of a body panel respectively, in which
a singular pillar part connects said assembly part with said hollow seal member,
said pillar part comprises curved parts and
said singular pillar part is cross-section roughly S-shaped that connects one curved part with the assembly part side of the other curved part; an outer peripheral surface of an arc of the one curved part faces an opposite side from said door sash side while an outer peripheral surface of an arc of the other curved part faces said door sash side, wherein:
a connecting position between said singular pillar part and said hollow seal member is on said door sash side compared with the top end of the anchoring part on the inner-cabin side provided on said door sash.

10. The assembly structure of the weather strip as claimed in claim 4, wherein:
a connecting position between said singular pillar part and said hollow seal member is on said door sash side compared with the top end of the anchoring part on the inner-cabin side provided on said door sash.

11. The assembly structure of the weather strip as claimed in claim 5, wherein:
a connecting position between said singular pillar part and said hollow seal member is on said door sash side compared with the top end of the anchoring part on the inner-cabin side provided on said door sash.

12. The assembly structure of the weather strip as claimed in claim 6, wherein:
a connecting position between said singular pillar part and said hollow seal member is on said door sash side compared with the top end of the anchoring part on the inner-cabin side provided on said door sash.

13. The assembly structure of the weather strip as claimed in claim 4, wherein:
said anchoring part on the inner-cabin side comprises: a cross-section concave receiving part which opens toward an outer-cabin side and in which a protruding end on an inner-cabin side formed on the assembly part of said weather strip is fit; and a rising part bent from an outer peripheral side end of said receiving part toward an inner-cabin side.

14. The assembly structure of the weather strip as claimed in claim 5, wherein:
said anchoring part on the inner-cabin side comprises: a cross-section concave receiving part which opens toward an outer-cabin side and in which a protruding end on an inner-cabin side formed on the assembly part of said weather strip is fit; and a rising part bent from an outer peripheral side end of said receiving part toward an inner-cabin side.

15. The assembly structure of the weather strip as claimed in claim 6, wherein:
said anchoring part on the inner-cabin side comprises: a cross-section concave receiving part which opens toward an outer-cabin side and in which a protruding end on an inner-cabin side formed on the assembly part of said weather strip is fit; and a rising part bent from an outer peripheral side end of said receiving part toward an inner-cabin side.

16. The assembly structure of the weather strip as claimed in claim 7, wherein:
said anchoring part on the inner-cabin side comprises: a cross-section concave receiving part which opens toward an outer-cabin side and in which a protruding end on all inner-cabin side formed on the assembly part of said weather strip is fit; and a rising part bent from an outer peripheral side end of said receiving part toward an inner-cabin side.

17. The assembly structure of the weather strip as claimed in claim 8, wherein:
said anchoring part on the inner-cabin side comprises: a cross-section concave receiving part which opens toward an outer-cabin side and in which a protruding end on an inner-cabin side formed on the assembly part of said weather strip is fit; and a rising part bent from an outer peripheral side end of said receiving part toward an inner-cabin side.

18. The assembly structure of the weather strip as claimed in claim 9, wherein:
said anchoring part on the inner-cabin side comprises: a cross-section concave receiving part which opens toward an outer-cabin side and in which a protruding end on an inner-cabin side formed on the assembly part of said weather strip is fit; and a rising part bent from an outer peripheral side end of said receiving part toward an inner-cabin side.

19. The assembly structure of the weather strip as claimed in claim 10, wherein:
said anchoring part on the inner-cabin side comprises: a cross-section concave receiving part which opens toward an outer-cabin side and in which a protruding end on an inner-cabin side formed on the assembly part of said weather strip is fit; and a rising part bent from an outer peripheral side end of said receiving part toward an inner-cabin side.

20. The assembly structure of the weather strip as claimed in claim 11 wherein:
said anchoring part on the inner-cabin side comprises: a cross-section concave receiving part which opens toward an outer-cabin side and in which a protruding end on an inner-cabin side formed on the assembly part of said weather strip is fit; and a rising part bent from an outer peripheral side end of said receiving part toward an inner-cabin side.

21. The assembly structure of the weather strip as claimed in claim 12, wherein:
said anchoring part on the inner-cabin side comprises: a cross-section concave receiving part which opens toward an outer-cabin side and in which a protruding end on an inner-cabin side formed on the assembly part of said weather strip is fit; and a rising part bent from an outer peripheral side end of said receiving part toward an inner-cabin side.
